(19) United States
(12) Patent Application Publication
(10) Pub. No.: US 2018/0137615 A1
(43) Pub. Date: May 17, 2018

(54) HIGH SPEED, FLEXIBLE PRETREATMENT PROCESS MEASUREMENT SCANNER

(71) Applicant: FORD MOTOR COMPANY, Dearborn, MI (US)

(72) Inventors: Jacqueline Arzate Alemán, Mexico (MX); Marcos Ahuizotl Fragoso Iñiguez, Neza (MX)

(21) Appl. No.: 15/352,838

(22) Filed: Nov. 16, 2016

(51) Int. Cl. G06T 7/00; G06T 7/40; G06F 3/048; G06F 17/30

(52) U.S. Cl. CPC G06T 7/0008; G06T 7/408; G06T 2207/10024; G06F 17/3028; G06T 2207/30164; G06F 3/048

(57) ABSTRACT

Methods for evaluating development of a foreign material include exposing a test vehicle element to conditions causing development of a foreign material and determining a color pattern of one or more captured test vehicle element images. The test vehicle element images may be captured before and/or during and/or after the test vehicle element is exposed to the conditions. A color analysis is performed which includes comparing a test color pattern obtained from the one or more captured test vehicle element images with one or more reference color patterns obtained from one or more clean vehicle element reference images and/or one or more contaminated vehicle element reference images. Systems are provided for performing the methods.

### TECHNICAL FIELD

This disclosure relates to devices and methods for inspecting and detecting defects in a portion of a surface of a workpiece. In particular, the disclosure relates to devices and methods for identifying pre-treatment process defects in a workpiece such as a vehicle body panel.

### BACKGROUND

During and after the manufacturing process, foreign materials may accumulate or develop on vehicle elements. For example, metal parts may develop rust, carbon, and other foreign materials over time. Likewise, non-metal vehicle elements such as filter materials which are exposed to humidity and moisture may develop foreign materials of a biological nature, for example molds and/or fungi. Plastic vehicle elements may develop nicks, scratches, or scuffs, and also embedded debris and others. Fabric or leather vehicle elements may develop scratches or cuts, and also may develop soiled areas. Such foreign materials may impair the utility and/or useful lifespan of the vehicle element. For example, carbon development on a metal part may cause increased friction and/or increased part wear.

For this reason, vehicle elements are typically evaluated for resistance to development of such foreign materials, in an effort to select or identify vehicle part constructs, materials, etc. which are more resistant to developing foreign materials. Resistant parts provide consumer benefits in terms of reduced repair/replacement costs. Likewise, resistant parts provide manufacturer benefits in terms of consumer satisfaction.

For consistency, standard operating procedures and uniform test procedures have been developed for evaluating development of foreign materials. For example, uniform test procedures have been established to determine carbon generation in engine injectors using different powertrain calibrations. Likewise, performance requirements and test procedures are known in the industry to determine development of bacteria, molds, fungi, etc. on air-conditioner (AC) filters. These uniform test procedures typically suffer from the same flaw, which is that the actual determination of foreign material development on the vehicle element is done by subjective visual analysis. Thus, the evaluations provided, even of a same part subjected to a same uniform test procedure, may vary widely from evaluator to evaluator.

Thus, a need is identified in the art for improvements to systems and methods for determining resistance of vehicle elements to development of foreign materials.

### SUMMARY

In accordance with the purposes and benefits described herein and to solve the above-summarized and other problems, in one aspect a system is provided for assessing development of a foreign material on a test vehicle element, comprising at least one imager and at least one processor associated with the at least one imager and comprising non-transitory computer-executable instructions for determining a color pattern of one or more captured test vehicle element images. In embodiments, the at least one processor and/or the at least one imager are associated with a user terminal. In other embodiments, the at least one processor and/or the at least one imager are associated with mobile computing device.

The system further comprises a stored database including one or more clean vehicle element reference images and/or one or more contaminated vehicle element reference images. The system may further include a graphical user interface associated with the at least one processor and configured for displaying and/or manipulating the one or more captured test vehicle element images and/or one or more clean vehicle element reference images and/or one or more contaminated vehicle element reference images.

In embodiments, the at least one processor is further configured to execute non-transitory computer-executable instructions for processing to identify one or more areas of the test vehicle element for analysis. In other embodiments, the at least one processor is further configured to execute non-transitory computer-executable instructions for processing to determine a degree of foreign material contamination of the test vehicle element.

The processing by the at least one processor in embodiments comprises a color analysis of the one or more captured test vehicle element images. The color analysis includes, by the at least one processor, comparing a test color pattern obtained from the one or more captured test vehicle element images with one or more reference color patterns obtained from the one or more clean vehicle element reference images and/or the one or more contaminated vehicle element reference images.

In another aspect, a method is provided for evaluating development of a foreign material, comprising exposing a test vehicle element to conditions causing development of a foreign material and, by at least one imager, capturing one or more test vehicle element images. The method further includes, by at least one processor associated with the at least one imager, determining a color pattern of the one or more captured test vehicle element images. The at least one processor and/or the at least one imager in embodiments may be associated with a user terminal or a mobile computing device.

The capturing of one or more test vehicle element images occurs before and/or during and/or after the exposing the test vehicle element to the conditions. The method further includes providing a stored database including one or more clean vehicle element reference images and/or one or more contaminated vehicle element reference images. The method further includes, by the at least one processor, performing a color analysis of the one or more captured test vehicle element images. The color analysis comprises, by the at least one processor, comparing a test color pattern obtained from the one or more captured test vehicle element images with one or more reference color patterns obtained from one or more clean vehicle element reference images and/or one or more contaminated vehicle element reference images.

In embodiments, the method further comprises configuring the at least one processor to execute non-transitory computer-executable instructions for processing to identify one or more areas of the test vehicle element for analysis. In other embodiments, the method includes configuring the at least one processor to execute non-transitory computer-executable instructions for processing to determine a degree of foreign material contamination of the test vehicle element.

A graphical user interface may be provided, associated with the at least one processor and configured for displaying and/or manipulating the one or more captured test vehicle element images and/or the one or more clean vehicle element reference images and/or the one or more contaminated vehicle element reference images.

In the following description, there are shown and described embodiments of systems and methods for determining resistance of vehicle elements to development of foreign materials. As it should be realized, the systems and methods are capable of other, different embodiments and their several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed systems and methods for determining resistance of vehicle elements to development of foreign materials, and together with the description serve to explain certain principles thereof. In the drawing:

FIG. 1 depicts a system for determining resistance of vehicle elements to development of foreign materials according to the present disclosure;

FIG. 2 depicts in flow chart form a method for determining resistance of vehicle elements to development of foreign materials according to the present disclosure;

FIG. 3 illustrates a color difference between clean (metal) and contaminated (carbon) areas of a test vehicle element;

FIG. 4 illustrates a representative neuronal network for use in the method of FIG. 2;

FIG. 5 illustrates a representative algorithm for use in training the neuronal network of FIG. 4; and

FIG. 6 illustrates a test for determining foreign material (carbon) build-up on a fuel injector, quantified by the method and system according to the present disclosure.

Reference will now be made in detail to embodiments of the disclosed systems and methods for determining resistance of vehicle elements to development of foreign materials, examples of which are illustrated in the accompanying drawing figures.

### DETAILED DESCRIPTION

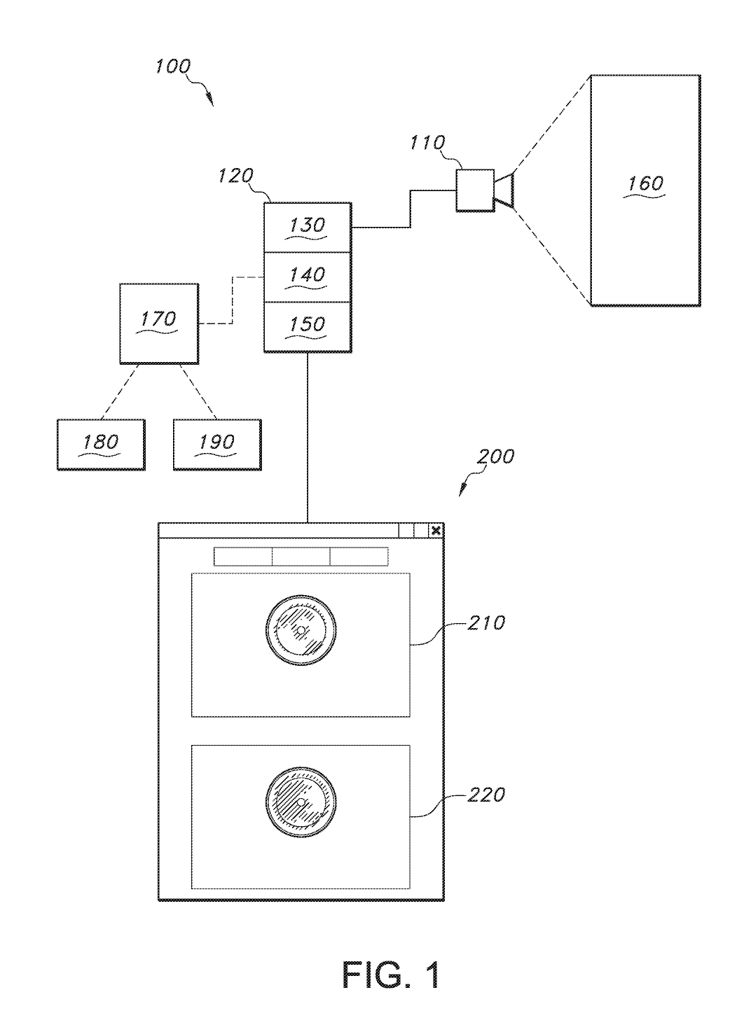

Reference is now made to FIG. 1 which schematically depicts a system 100 for evaluating determining resistance of vehicle elements to development of foreign materials. The system includes one or more imagers 110 operatively connected to a computing device 120 including at least one processor 130, at least one memory 140, and storage 150. The one or more imagers 110 are configured to transmit digital data of images of an entirety or a portion of a test vehicle element 160 to the computing device 120 for processing as will be discussed below. The digital data may be transmitted on capture of an image, or in an alternative embodiment the at least one processor 130 could be configured to automatically fetch image data from the one or more imagers 110 at predetermined time intervals over a predetermined test period.

The computing device 120 may be a substantially stationary user terminal or may be a mobile computing device. Indeed, the system 100 may be implemented by any suitable computing device such as, but not limited to, a tablet device, a handheld device, a laptop or desktop computer, a personal-digital assistant device, a cellular phone, a smartphone, and/or any other computing device comprising an imager 110 and configured to perform one or more of the processes and/or operations described herein.as is known, such as a mobile phone (e.g., a cellular phone or smartphone). The system 100 further includes a stored database 170, which may be stored remotely from the computing device 120 or may be stored in memory 140, comprising one or more clean vehicle element reference images 180 and/or one or more contaminated vehicle element reference images 190.

It will be understood that “test” vehicle element 160 means a particular vehicle element being evaluated for resistance or susceptibility to development of a foreign material. By “clean,” and “contaminated” vehicle element reference images, it will be understood that it is meant images of a like vehicle element without traces of the foreign material (“clean”) and/or images of a like vehicle element including varying degrees of development of the foreign material (“contaminated”).

In one embodiment, the system 100 comprises a stationary or handheld imager 110 connected to the computing device 120 by wired or wireless communications. In another embodiment, the system 100 comprises a handheld computing device 120 (i.e., a laptop computer, a tablet computer, a cellular phone, a smartphone, etc.) comprising an integrated imager 110. In use, the imager 110 is used to capture one or more test vehicle element 160 images, which are processed and analyzed as will be described in detail below.

The system 100 may further include a graphical user interface (GUI) 200 configured for selecting an image to be processed and/or a region of an image to be processed. In an embodiment, a MATLAB® GUI 200 was developed. In the depicted embodiment, there is shown a test vehicle element image 210, and a corresponding processed test vehicle element image 220. In the depicted embodiment, the test vehicle element image 210 and the processed test vehicle element image 220 are of a carbon build-up on a fuel injector.

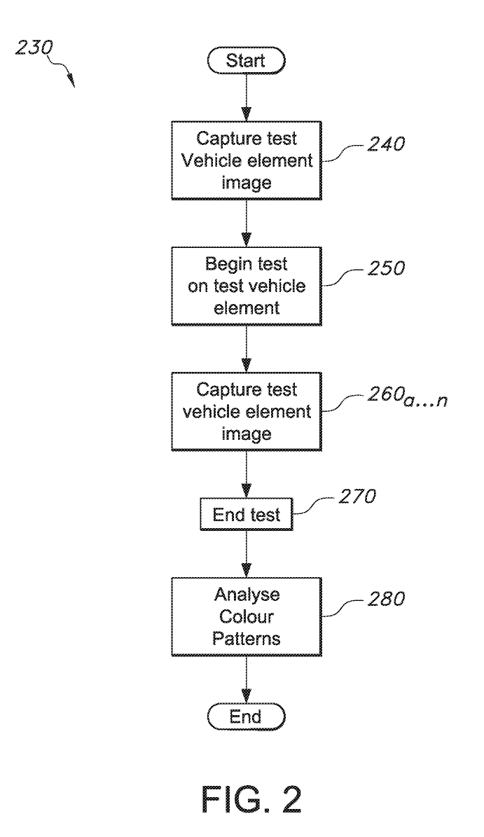

By the described system 100, a method 230 (see FIG. 2) is provided for evaluating determining resistance of vehicle elements to development of foreign materials. At a high level, the method 230 provides, by a color analysis of a test vehicle element image 210, a measure of contamination by a foreign material of a test vehicle element 160, as well as in embodiments a measure of the degree of contamination, the areas of the test vehicle element contaminated, and other features.

At step 240, a first image is captured of a test vehicle element 160. This image is of a clean test vehicle element 160. Preferably the image should not include background “noise” such as stray light, shadows, camera flashes, and the like. If necessary to determine dimensions of a surface or test vehicle element 160 being imaged, reference features such as circles having a known diameter, lines of a known length, and others may be disposed near the surface/test vehicle element 160 being imaged. The stationary or handheld imager 110 should be disposed whereby an image is taken at an angle substantially perpendicular to the surface or test part being imaged, and whereby the surface or test part being imaged comprises approximately 50% of the imager 110 field of view.

Next, at step 250 a suitable test intended to cause development of a foreign material on the test vehicle element 160 is initiated. It will be appreciated that the nature and design of the test will vary according to the test vehicle element 160 and the foreign material to be evaluated. For example, in the case of a test vehicle element 160 that is a fuel injector, the test may comprise operating a fuel injected engine over a period of time under conditions potentially causing carbon build-up. In the case of a test vehicle element 160 that is an A/C filter, the test may comprise operating a vehicle heating, ventilation, and air-conditioning (HVAC) system under conditions of temperature and humidity to evaluate growth of mold, fungi, bacteria, etc. on a filter material.

At step 260 a . . . n, one or more additional test vehicle element 160 images 210 are captured. In one embodiment, one or more additional test vehicle element images 210 are captured at predetermined intervals during the duration of the test. In another embodiment, one or more additional test vehicle element images 210 are captured concurrently with or immediately after termination of the test. In yet another embodiment, the one or more additional test vehicle element images 210 are captured at predetermined intervals during the duration of the test and concurrently with or immediately after termination of the test. As will be appreciated, by these captured test vehicle element images 210 a progression of development of the foreign material can be determined.

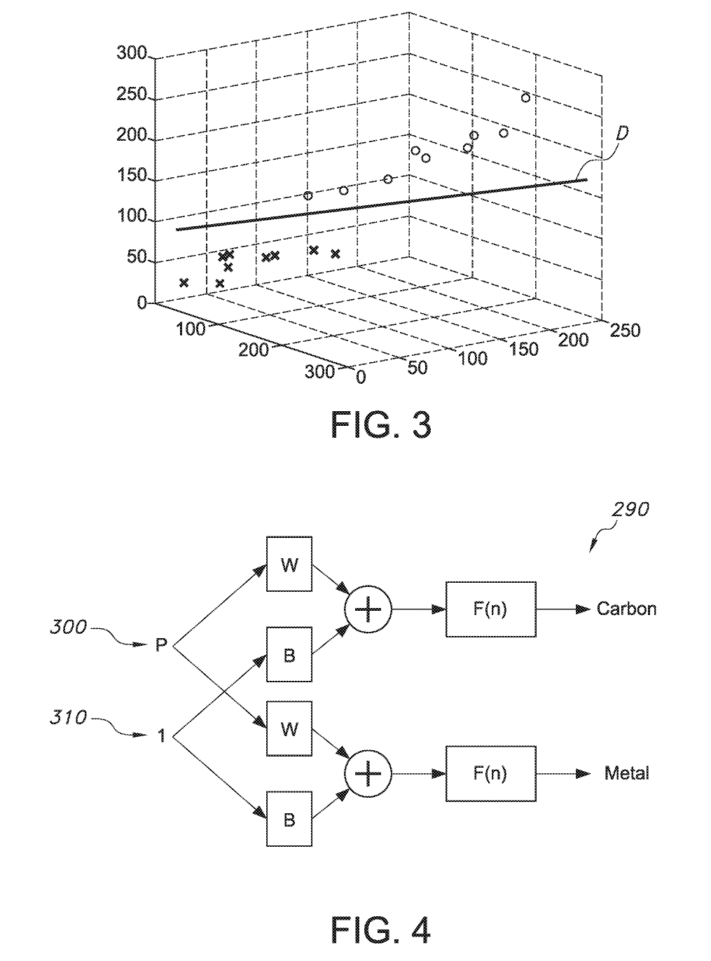

Next is a step 280 of color analysis of the test vehicle element images. As will be appreciated, clean areas of a material of the test vehicle element 160 will present a different color pattern compared to areas wherein a foreign material has developed or is developing. By the presently described system 100 and method 230, this can be used to ascertain a susceptibility or resistance of the test vehicle element 160 to development of the foreign material. As one non-limiting example, with reference to FIG. 3 and again using the example of carbon build-up on metal of a fuel injector, it can be seen that a clear demarcation D exists between the color patterns of the metal (x) and the color patterns of carbon (*).

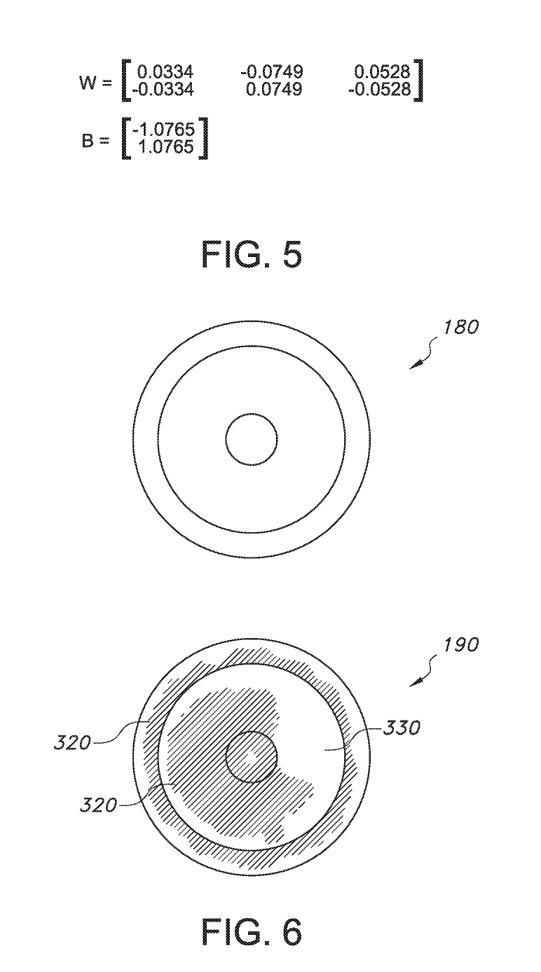

Advantageously, this difference in color patterns between clean and contaminated test vehicle elements 160 allows application of a two-neuron adaptive neuronal network analysis to determine foreign material contamination by distinguishing foreign material from underlying test vehicle element 160 by color according to three inputs [(one for each color red-green-blue (RGB)]. With reference to FIG. 4, a representative two-neuron adaptive neuronal network 290 for distinguishing metal from carbon in captured images is depicted, showing a first neuron 300 for determination of carbon and a second neuron 310 for determination of metal. A representative algorithm for the above analysis and for training the neurons 300, 310 is presented in FIG. 5. In the representative algorithm: W is a synaptic weight matrix, which determines a decision surface; b is a polarization vector, which provides a direction for the decision surface; F(n) is a decision function which gives the shape of the decision surface; and P is an entry patron for data entry,

As discussed above, the system 100 includes a stored database 170 comprising one or more clean vehicle element reference images 180 and/or one or more contaminated vehicle element reference images 190. Again returning to the non-limiting example of a fuel injector, FIG. 6 depicts an example of a clean vehicle element (fuel injector) reference image 180 and/or one or more contaminated vehicle element (fuel injector) reference image 190, processed by the processor 130 and GUI 200 to isolate the portion of the images including the fuel injectors. As can be seen, the carbon-contaminated portions 320 can be clearly distinguished from the clean metal portions 330.

It will be appreciated that only images of the test vehicle element 160 may be used and still provide a satisfactory result, as the contaminated portions 320 can clearly be distinguished from the clean portions 330. This is illustrated in FIGS. 1 and 6, showing an image of a contaminated vehicle element reference image 190 displayed in the system GUI 200. As will be appreciated, the contaminated portions 320 can readily be quantified (i.e., percent contaminated versus percent clean in the image) by methods known in the art.

Alternatively, however, as noted above the database 170 may comprise one or more clean vehicle element reference images 180 and/or one or more contaminated vehicle element reference images 190. By providing one or more contaminated vehicle element reference images 190 defining various incrementally increasing degrees of contamination, the system 100 can simply compare the one or more test vehicle element images 210 with those one or more clean vehicle element reference images 180 and/or one or more contaminated vehicle element reference images 190 to determine a location and degree of contamination.

As will be appreciated, by its adaptive nature the system 100 adaptive neuronal network 290 adds to its knowledge base (database 170) with every test performed, since the one or more test vehicle element images 210 can be added to the database to further expand and refine the pool of contaminated vehicle element reference images 190 available for comparison. By this process, the system 100 “learns” with each subsequent test.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A system for assessing development of a foreign material on a test vehicle element, comprising:
at least one imager; and
at least one processor associated with the at least one imager and comprising non-transitory computer-executable instructions for determining a color pattern of one or more captured test vehicle element images.

2. The system of claim 1, wherein the at least one processor and/or the at least one imager are associated with a user terminal or a mobile computing device.

3. The system of claim 1, further comprising a stored database including one or more clean vehicle element reference images and/or one or more contaminated vehicle element reference images.

4. The system of claim 3, wherein the at least one processor is further configured to execute non-transitory computer-executable instructions for processing to identify one or more areas of the test vehicle element for analysis.

5. The system of claim 3, wherein the at least one processor is further configured to execute non-transitory computer-executable instructions for processing to determine a degree of foreign material contamination of the test vehicle element.

6. The system of claim 5, wherein the processing comprises a color analysis of the one or more captured test vehicle element images.

7. The system of claim 6, wherein the color analysis comprises, by the at least one processor, comparing a test color pattern obtained from the one or more captured test vehicle element images with one or more reference color patterns obtained from the one or more clean vehicle element reference images and/or the one or more contaminated vehicle element reference images.

8. The system of claim 3, further including a graphical user interface associated with the at least one processor and configured for displaying and/or manipulating the one or more captured test vehicle element images and/or the one or more clean vehicle element reference images and/or the one or more contaminated vehicle element reference images.

9. A method for evaluating development of a foreign material, comprising:
exposing a test vehicle element to conditions causing development of a foreign material;
by at least one imager, capturing one or more test vehicle element images; and
by at least one processor associated with the at least one imager, determining a color pattern of the one or more captured test vehicle element images.

10. The method of claim 9, wherein the at least one processor and/or the at least one imager are associated with a user terminal or a mobile computing device.

11. The method of claim 9, wherein the capturing of one or more test vehicle element images occurs before and/or during and/or after the exposing the test vehicle element to the conditions.

12. The method of claim 9, further comprising providing a stored database including one or more clean vehicle element reference images and/or one or more contaminated vehicle element reference images.

13. The method of claim 12, further comprising configuring the at least one processor to execute non-transitory computer-executable instructions for processing to identify one or more areas of the test vehicle element for analysis.

14. The method of claim 12, further comprising configuring the at least one processor to execute non-transitory computer-executable instructions for processing to determine a degree of foreign material contamination of the test vehicle element.

15. The method of claim 14, wherein the processing comprises, by the at least one processor, performing a color analysis of the one or more captured test vehicle element images.

16. The method of claim 15, wherein the color analysis comprises, by the at least one processor, comparing a test color pattern obtained from the one or more captured test vehicle element images with one or more reference color patterns obtained from one or more clean vehicle element reference images and/or one or more contaminated vehicle element reference images.

17. The method of claim 16, further including providing a graphical user interface associated with the at least one processor and configured for displaying and/or manipulating the one or more captured test vehicle element images and/or the one or more clean vehicle element reference images and/or the one or more contaminated vehicle element reference images.

18. A system for assessing development of a foreign material on a test vehicle element, comprising:
at least one imager;
at least one processor associated with the at least one imager and comprising non-transitory computer-executable instructions for determining a color pattern of one or more captured test vehicle element images; and
a stored database including one or more clean vehicle element reference images and/or one or more contaminated vehicle element reference images.

19. The system of claim 18, wherein the at least one processor and/or the at least one imager are associated with a user terminal or a mobile computing device.

20. The system of claim 18, wherein the at least one processor is configured to execute non-transitory computer-executable instructions for processing to determine a degree of foreign material contamination of the test vehicle element by a color analysis comprising:
by the at least one processor, comparing a test color pattern obtained from the one or more captured test vehicle element images with one or more reference color patterns obtained from the one or more clean vehicle element reference images and/or the one or more contaminated vehicle element reference images.
